(19) United States
(12) Patent Application Publication
(10) Pub. No.: US 2015/0178915 A1
(43) Pub. Date: Jun. 25, 2015

(54) Tagging Images With Emotional State Information

(71) Applicant: Microsoft Corporation, Redmond, WA (US)

(72) Inventors: Monique Chatterjee, Seattle, WA (US); Benoit Collette, Seattle, WA (US); Fernd VanEngelen, Bothell, WA (US); Stephanie Hughes, Seattle, WA (US)

(73) Assignee: Microsoft Corporation, Redmond, WA (US)

(21) Appl. No.: 14/134,863

(22) Filed: Dec. 19, 2013

(51) Int. Cl. G06T 7/00; G06K 9/80; G06K 9/20

(52) U.S. Cl. CPC G06T 7/0012; G06K 9/20; G06K 9/80; G06K 2209/27; G06T 2207/10004; G06T 2207/30004

(57) ABSTRACT

Images, such as photographs or videos, are tagged with emotional state and/or biometric information. Emotional state information (or mood) may be stored in metadata of an electronic image. A computing device, such as a cellular telephone, receives an image from a camera as well as biometric information from a sensor. Sensors may be located on the computing device, or alternatively on a user wearable device. Biometric information may be from a user taking a photograph or from a user viewing a photograph. Biometric information may include heart rate, galvanic skin response (GSR), facial expression and the like. The computing device may calculate an emotional state of a user, such as happiness, based on the biometric information. The tagged biometric and/or emotional state information allows for a way to retrieve, sort and organize images. Tagged images may be used in social media connections or broadcasting, such as blogging specific emotional images.

### BACKGROUND

Different types of computing devices may capture or take an electronic image of a subject or object. For example, a user may use a camera or video recorder to take a photograph or video of a person or scene. Other computing devices may also capture images, such as electronic billboards, personal computers, laptops, notebooks, tablets, telephones or wearable computing devices.

Captured images may be stored locally in the computing device, or transferred to a remote computing device for storage. Similarly, images may be retrieved and viewed by the computing device that took the image, or alternatively the image may be viewed on a display of a different computing device at a remote site.

### SUMMARY

The technology includes a way to tag images, such as photographs or videos, with emotional state and/or biometric information. Emotional state information (or mood) may be stored in metadata of an electronic image. A computing device, such as a cellular telephone or game and media console, receives an image from a camera as well as biometric information from sensors. Sensors may be located on the computing device or alternatively on a user wearable device. Biometric information may come from a user taking a photograph or from a user viewing a photograph. Biometric information may include heart rate, galvanic skin response (GSR), facial expression, temperature, glucose level and/or hydration. The computing device may calculate an emotional state of a user, such as happiness or anger, based on the biometric information. The tagged biometric and/or emotional state information allows for a way to retrieve, sort and organize images for at least personal viewing, self-discovery, diagnosis or marketing. Tagged images may be used in social media connections or broadcasting, such as blogging specific emotional images (a.k.a. “lifecasting”).

The technology may be used in a variety of embodiments. For example, millions of photographs and videos are taken each year. When emotional state and/or biometric information is included with the image, an individual is able to retrieve, sort and organize the images based on that information. For example, a user may be able to identify the most enjoyable portion or time of a vacation by sorting images based on an emotional state of when the photograph was taken or when the photograph was viewed by the user.

Typically, a brain recalls events by remembering key moments and then filling in the details around them. When images are marked with emotional state and/or biometric information, a user can search images that are correlated to the physical/emotional highs and lows of a particular event. These images will serve as key frames, and a user's memory of the event may be much richer and more complete than just looking at random photos. A user may create the ‘ideal/most powerful’ scrapbook or photo album of a particular experience/vacation/event by key framing images by emotional state/biometric tags.

Individuals may not realize what they eat and how it makes them feel. Individuals spend millions of dollars on fad diets, gyms that they don't use, and other efforts to lose weight. They often overlook the simple solution of taking time to get to know what they eat and the way the food makes them feel. For example, a food item may be photographed, and a dieter's emotional state/biometric information may be tracked alongside the photographs. A timeline of a dieter's daily consumption may be overlaid with how it made the dieter physically feel. This information may then be provided to the dieter, who may find patterns in emotional states and consumed food. In an embodiment, a food journal may be created. For instance, a dieter could discover that every time they ate a kale salad with fish for dinner, they had more energy the next morning. Or a dieter could see that the first and second cookie were OK, but the dieter became overly energetic after the third one.

In another embodiment, a company (such as a retailer) could take advantage of capturing a user's emotional state/biometric information as they peruse images online to understand what is effective and what isn't. A company may want to know what emotions and reactions are sparked by which images, or understand what type of individuals reacts to specific merchandise.

In yet another embodiment, individuals often like to take photographs, but often miss the moments that really matter. When a user feels a peak in physicality or emotion, a camera may be triggered to capture an image. This may increase the likelihood that the key frames in an experience are captured with little effort from a user.

In another embodiment, medical professionals could see an overlay of the patient's emotional state/biometric information over a visual diary of their day. This information could be used in understanding patients, recognizing patterns, and visualizing situations.

In yet another embodiment, images with cumulative emotional state/biometric information may be posted on web sites to identify vacation destinations, hotels, and/or restaurants that make patrons or a user feel a particular way. For example, a user could see that 80% of the patrons that visit a particular lakeside B&B are extremely calm and relaxed. Or, of the three amusement parks in the area—which is most exciting and which is most frustrating. In this embodiment, images are captured with emotional state/biometric tags by people in the community. Those images are then averaged and uploaded to the web with the emotional state/biometric information visible for others to use.

A method embodiment of operating a computing device includes receiving, from an image capture device, an image obtained from the image capture device. Sensor information that represents biometric information when the image was obtained from the image capture device is also received from a sensor. Emotional state information associated with the image based on the sensor information is determined. The emotional state information is associated and stored with the image.

An apparatus embodiment comprises a sensor to obtain biometric information, a camera to obtain an image, one processor and one processor readable memory to store processor readable instructions. The one processor executes the processor readable instructions to: 1) receive sensor information that represents biometric information from the sensor; 2) receive an image from the camera, 3) calculate emotional state information associated with the image based on the sensor information that represents biometric information; and 4) store the emotional state information with the image.

In another embodiment, one or more processor readable memories include instructions which when executed cause one or more processors to perform a method for providing an image in response to a request for an image having a requested emotional state. The method comprises receiving sensor information that represents biometric information from a sensor. An image from a camera is also received. Emotional state information associated with the image based on the sensor information that represents biometric information is calculated and stored with the image. A request for an image having a requested emotional state is received. The image is provided in response to the request for an image having the requested emotional state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high-level block diagram of an exemplary system architecture.

FIG. 2 is a high-level block diagram of an exemplary software architecture.

FIG. 3A illustrates an exemplary data structure including metadata and image data.

FIG. 3B illustrates exemplary sets of numbers for associated emotional states in a range of emotional state values.

FIGS. 4A-C illustrate exemplary types of sensors for obtaining biometric information.

FIGS. 5 and 6A-B are flow charts of exemplary methods to tag and retrieve images having emotional state values.

FIG. 7 is an isometric view of an exemplary gaming and media system.

FIG. 8 is an exemplary functional block diagram of components of the gaming and media system shown in FIG. 7.

FIG. 9 illustrates an exemplary computing device.

### DETAILED DESCRIPTION

The technology includes a way to tag images, such as photographs or videos, with emotional state and/or biometric information. Emotional state information (or mood) may be stored in metadata of an electronic image. A computing device, such as a cellular telephone or game and media console, receives an image from a camera as well as biometric information from sensors. Sensors may be located on the computing device or alternatively on a user wearable device. Biometric information may come from a user taking a photograph or from a user viewing a photograph. Biometric information may include heart rate, galvanic skin response (GSR), facial expression, temperature, glucose level and/or hydration. The computing device may calculate an emotional state of a user, such as happiness or anger, based on the biometric information. The tagged biometric and/or emotional state information allows for a way to retrieve, sort and organize images for at least personal viewing, self-discovery, diagnosis or marketing. Tagged images may be used in social media connections or broadcasting, such as blogging specific emotional images (a.k.a. “lifecasting”).

The technology may be used in a variety of embodiments. For example, millions of photographs and videos are taken each year. When emotional state and/or biometric information is included with the image, an individual is able to retrieve, sort and organize the images based on that information. For example, a user may be able to identify the most enjoyable portion or time of a vacation by sorting images based on an emotional state of when the photograph was taken or when the photograph was viewed by the user.

Typically, a brain recalls events by remembering key moments and then filling in the details around them. When images are marked with emotional state and/or biometric information, a user can search images that are correlated to the physical/emotional highs and lows of a particular event. These images will serve as key frames, and a user's memory of the event may be much richer and more complete than just looking at random photos. A user may create the ‘ideal/most powerful’ scrapbook or photo album of a particular experience/vacation/event by key framing images by emotional state/biometric tags.

Individuals may not realize what they eat and how it makes them feel. Individuals spend millions of dollars on fad diets, gyms that they don't use, and other efforts to lose weight. They often overlook the simple solution of taking time to get to know what they eat and the way the food makes them feel. For example, a food item may be photographed, and a dieter's emotional state/biometric information may be tracked alongside the photographs. A timeline of a dieter's daily consumption may be overlaid with how it made the dieter physically feel. This information may then be provided to the dieter, who may find patterns in emotional states and consumed food. In an embodiment, a food journal may be created. For instance, a dieter could discover that every time they ate a kale salad with fish for dinner, they had more energy the next morning. Or a dieter could see that the first and second cookie were OK, but the dieter became overly energetic after the third one.

In another embodiment, a company (such as a retailer) could take advantage of capturing a user's emotional state/biometric information as they peruse images online to understand what is effective and what isn't. A company may want to know what emotions and reactions are sparked by which images, or understand what type of individuals reacts to specific merchandise.

In yet another embodiment, individuals often like to take photographs, but often miss the moments that really matter. When a user feels a peak in physicality or emotion, a camera may be triggered to capture an image. This may increase the likelihood that the key frames in an experience are captured with little effort from a user.

In another embodiment, medical professionals could see an overlay of the patient's emotional state/biometric information over a visual diary of their day. This information could be used in understanding patients, recognizing patterns, and visualizing situations.

In yet another embodiment, images with cumulative emotional state/biometric information may be posted on web sites to identify vacation destinations, hotels, and/or restaurants that make patrons or a user feel a particular way. For example, a user could see that 80% of the patrons that visit a particular lakeside B&B are extremely calm and relaxed. Or, of the three amusement parks in the area—which is most exciting and which is most frustrating. In this embodiment, images are captured with emotional state/biometric tags by people in the community. Those images are then averaged and uploaded to the web with the emotional state/biometric information visible for others to use.

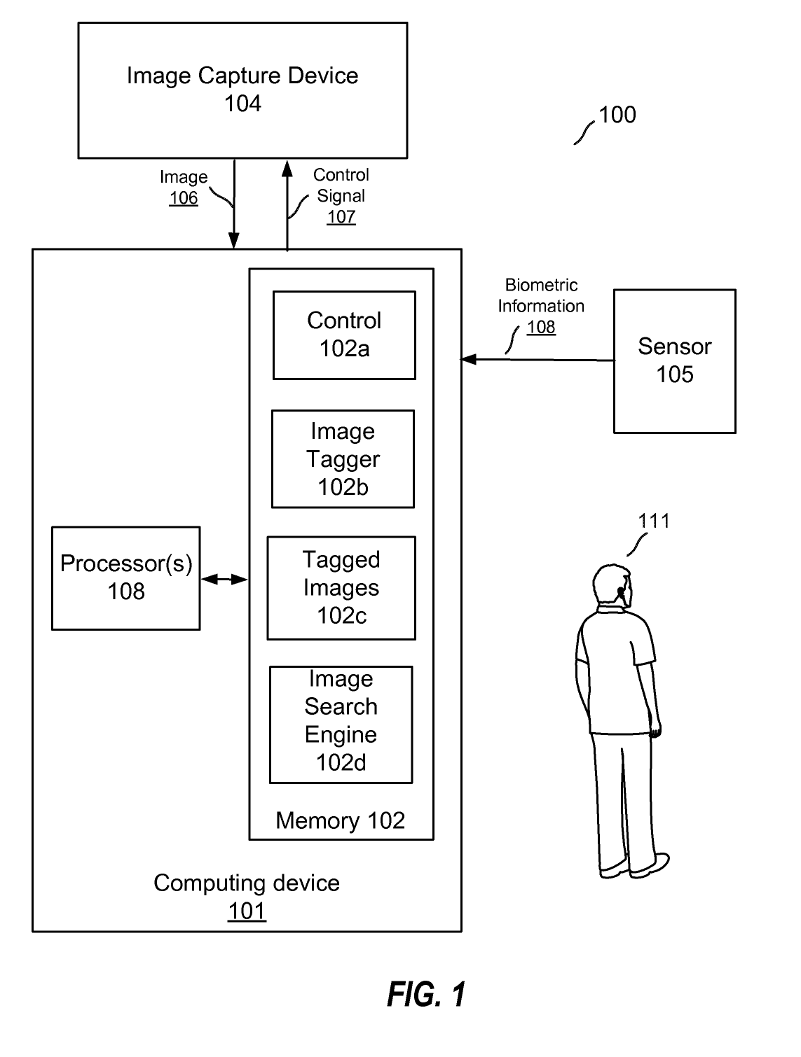

FIG. 1 is a high-level block diagram of an apparatus (or system) 100 for processing an image, such as a photograph or video. In particular, apparatus 100 tags images with emotional state and/or biometric information of a user such that the images may be retrieved, sorted and/or organized by emotional state and/or biometric information. In an embodiment, apparatus 100 includes an image capture device 104 (such as a camera), computing device 101 and sensor 105. In an embodiment, image capture device 104 takes an image 106 while sensor 105 obtains biometric information 103 from a user 111. In an embodiment, sensor 105 obtains biometric information 103 while a user 111 is taking a photograph or video, or alternatively while user 111 is viewing photographs or videos. Image capture device 104 transfers an image 106 to computing device 101 and sensor 105 transfers biometric information 103 to computing device 101.

Computing device 101 includes a processor(s) 108 that executes processor readable instructions stored in memory 102 to tag image 106 with biometric information 103 and/or emotional state information of user 111. In an embodiment, memory 102 is processor readable memory that stores software components, such as control 102a, image tagger 102b and image search engine 102d. In an embodiment, memory 102 also stores tagged images 102c. In an alternate embodiment, tagged images 102c are stored at a remote computing device.

In an embodiment, image capture device 104, computing device 101 and sensor 105 are package and included in a single device. For example, image capture device 104, computing device 101 and sensor 105 may be included in a cellular telephone. Image capture device 104 may be a camera included in the cellular telephone. Sensor 105 may include a surface of a cellular telephone that obtains biometric information 103 from user 111. Similarly, image capture device 104, computing device 101 and sensor 105 may be packaged in a single game and media console as described herein. Sensor 105 may be another camera in a game console that obtains biometric information, such as user 111 facial expressions while image capture device 104 takes photographs of user 111 playing the game and media console. In an alternate embodiment, sensor 105 may be included in a controller used by user 111 to operate a game and media console.

In still further embodiments, image capture device 104 and sensor 105 may be included in a single package device, such as a camera, while computing device 101 may be included in a separate package, such as laptop computer or tablet computer. Similar to the cellular telephone embodiment, sensor 105 may be included on a surface of a camera that obtains biometric information 103 from a user 111. In another embodiment, sensor 105 and computing device 101 is included in a single package, while image capture device 104 is in a separate package.

In yet another embodiment, image capture device 104 and computing device 101 may be combined in a single package or in separate packaging, while sensor 105 is in a different package, such as a wearable sensor.

Computing device 101, image capture device 104 and sensor 105 may transfer information, such as images, control and biometric information, by wired or wireless connections. Computing device 101, image capture device 104 and sensor 105 may communicate by way of a network, such as a Local Area Network (LAN), Wide Area Network (WAN) and/or the Internet.

In an embodiment, control 102a outputs a control signal 107 to image capture device 104 to take a photograph or video based on biometric information 103. For example, when biometric information indicates a particular high emotional state of user 111, such as extreme happiness, control signal 107 is output so that image capture device 104 takes a photograph or video of what may be causing the desirable emotional state. In an alternate embodiment, control 102a outputs a control signal in response to biometric information, such as increased heart rate variation. In an embodiment, control 102a is responsible for at least controlling other software components (and their interaction) illustrated in computing device 101.

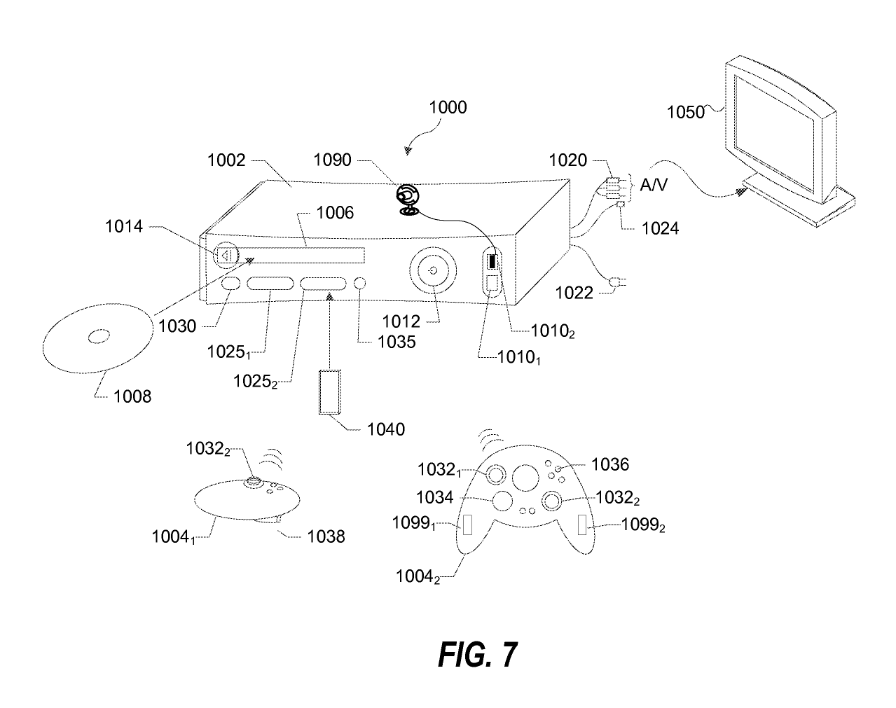

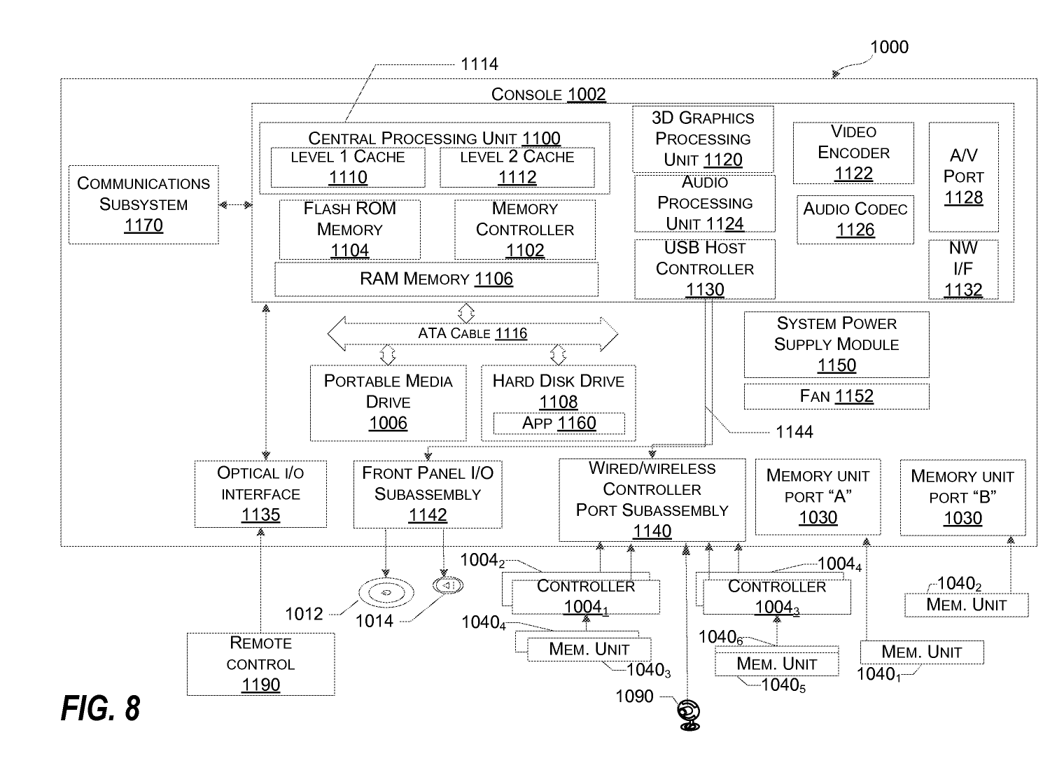

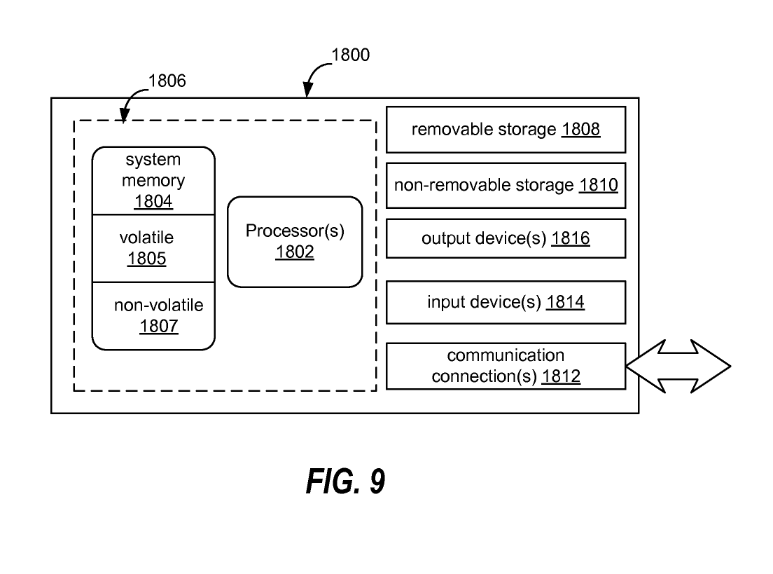

In an embodiment, computing device 101, image capture device 104 and sensor 105 is included in a game and media console described herein and illustrated in FIGS. 7 and 8. In an alternate embodiment, computing device 101 (and image capturing device 104 in an embodiment) corresponds to a computing device as illustrated in FIG. 9 and described herein. In alternate embodiments, computing device 101 may be included in at least a cellular telephone, tablet computer, notebook computer, laptop computer and desktop computer.

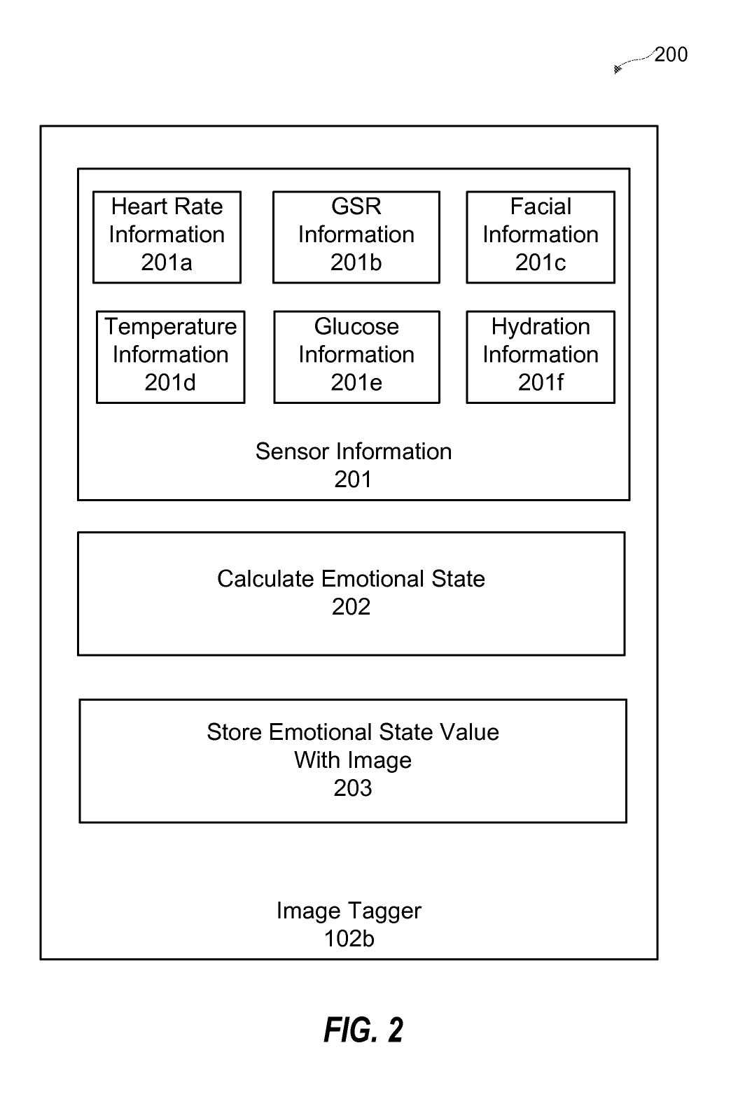

FIG. 2 is a high-level block diagram of an exemplary software architecture 200 of image tagger 102b that processes an image.

In an embodiment, image tagger 102b includes at least one software component. In embodiments, a software component may include a computer (or software) program, object, function, subroutine, method, instance, script and/or processor readable instructions, or portion thereof, singly or in combination. One or more exemplary functions that may be performed by the various software components are described below. In alternate embodiment, more or less software components and/or functions of the software components described below may be used.

In an embodiment, image tagger 102b is responsible for receiving and processing sensor information that includes biometric information, calculating an emotional state of a user based on the biometric information and/or storing emotional state information (or an emotional state value) with an associated image. In another embodiment, biometric information is stored with the associated image.

In an embodiment, image tagger 102b includes software components such as sensor information 201, calculate emotional state 202 and store emotional state value with image 203.

Sensor information 201 is responsible for receiving and storing biometric information from a user, such as user 111 shown in FIG. 1. In an embodiment, sensor information 201 receives biometric information including, but not limited to, heart rate, GSR, facial expression, temperature, glucose level and/or hydration.

Heart rate information 201a, in an embodiment, is responsible for receiving and storing heart rate information of a user. In an embodiment, the variation of heart rate of a user is calculated and stored. In an embodiment, heart rate information 201a includes a typical heart rate of a user or a history of heart rate information of the user in different scenarios or events.

GSR information 201b, in an embodiment, is responsible for receiving and storing GSR information of a user. In an embodiment, GSR information 201b includes a typical GSR of a user or a history of GSR information of the user in different scenarios or events.

Facial information 201c, in an embodiment, is responsible for receiving and storing facial information of a user. In an embodiment, facial information 201c includes a typical facial expression, facial information of a user, or a history of facial information of the user in different scenarios or events.

Temperature information 201d, in an embodiment, is responsible for receiving and storing temperature information of a user. In an embodiment, temperature information 201d includes a typical temperature of a user, or a history of temperature information of the user in different scenarios or events.

Glucose information 201e, in an embodiment, is responsible for receiving and storing glucose information of a user. In an embodiment, glucose information 201e includes a typical glucose level of a user, or a history of glucose levels of the user in different scenarios or events.

Hydration information 201f, in an embodiment, is responsible for receiving and storing hydration information of a user. In an embodiment, hydration information 201f includes a typical hydration level of a user, or a history of hydration levels of the user in different scenarios or events.

Calculate emotional state 202, in an embodiment, is responsible for assigning an emotional state value based on at least some of the biometric information in sensor information 201. Calculate emotional state 202 may calculate and assign a number value in a range of numbers associated with a range of emotional states (or range of emotions or moods). For example, calculate emotional state 202 may calculate and assign a 95 value (in a range of 1 to 100) for an image (based on the biometric information) that represents that the user was very happy when taking or viewing the image.

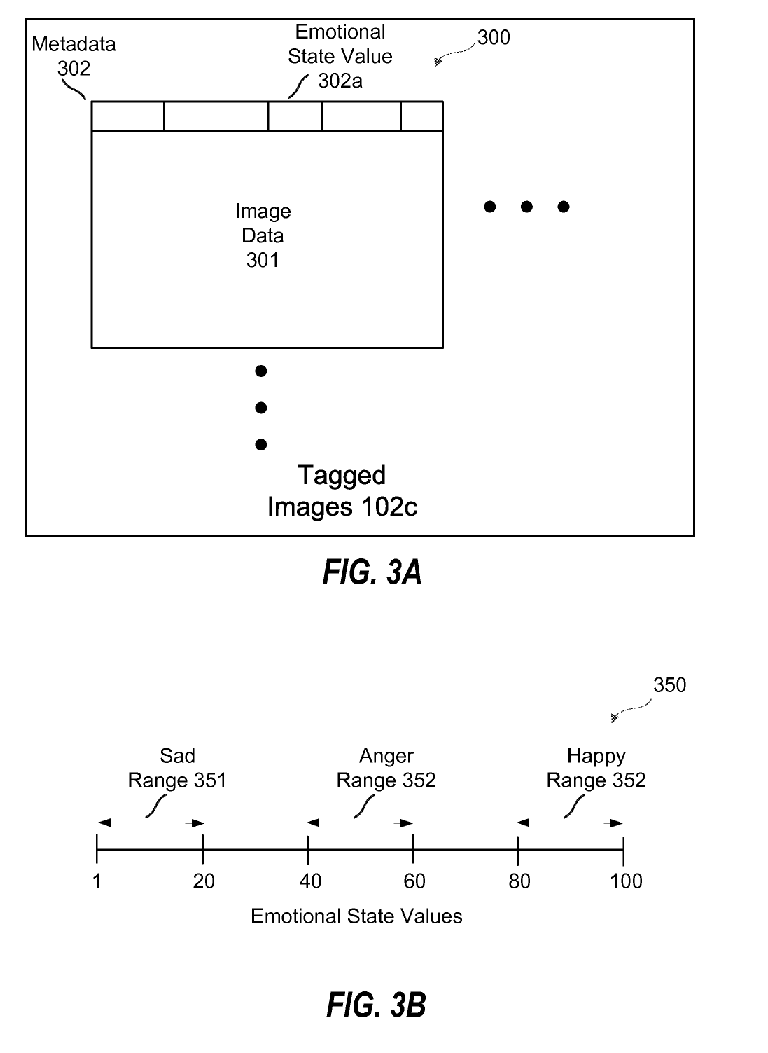

FIG. 3B illustrates a range of numbers 350 ranging from 1 to 100 having associated emotional state ranges or sets of numbers. In alternate embodiments, a different range of numbers may be used with a different number or type of associated emotional state ranges (such as sadness range 351, anger range 352, and happiness range 353 shown in FIG. 3B). In an embodiment, emotional state ranges may overlap.

In an embodiment, a sadness range 351 is defined as emotional state values in the set of numbers between 1 and 20, with 1 being the saddest and 20 being the least sad in the sadness range 351. Similarly, an anger range 352 is defined as the set of numbers between 40 and 60, with 40 being the least angry (or having the least anger) and 60 being the angriest in the anger range 352. A happiness range 353 is defined as the set of numbers between 80 and 100, with the 80 being the least happy and 100 being the happiest in the happiness range 353.

Store emotional state values with image 203, in an embodiment, is responsible for tagging or including a calculated emotional state value for an image outputted from calculate emotional state information 202 with the associated image. In an embodiment, images with tagged or included emotional state information are stored in tagged images 102c.

FIG. 3A illustrates a data structure 300 of an image that includes an associated emotional state information. In particular, an emotional state value 302a, such as 95 for happiness in the example above, is stored in a field of metadata 302 while image information is stored in image data 301, such as color or pixel information of the image. In an alternate embodiment, biometric information is stored with the image, or in metadata 302, rather than emotional state value 302a. In still a further embodiment, biometric information and an emotional state value is stored in metadata 302. In an embodiment, data structure 300 is a Joint Photographic Experts Group (JPEG) file. Metadata in a JPEG file from a camera may contain other information, such as the camera's make and model, focal and aperture information, and timestamps (along with other information).

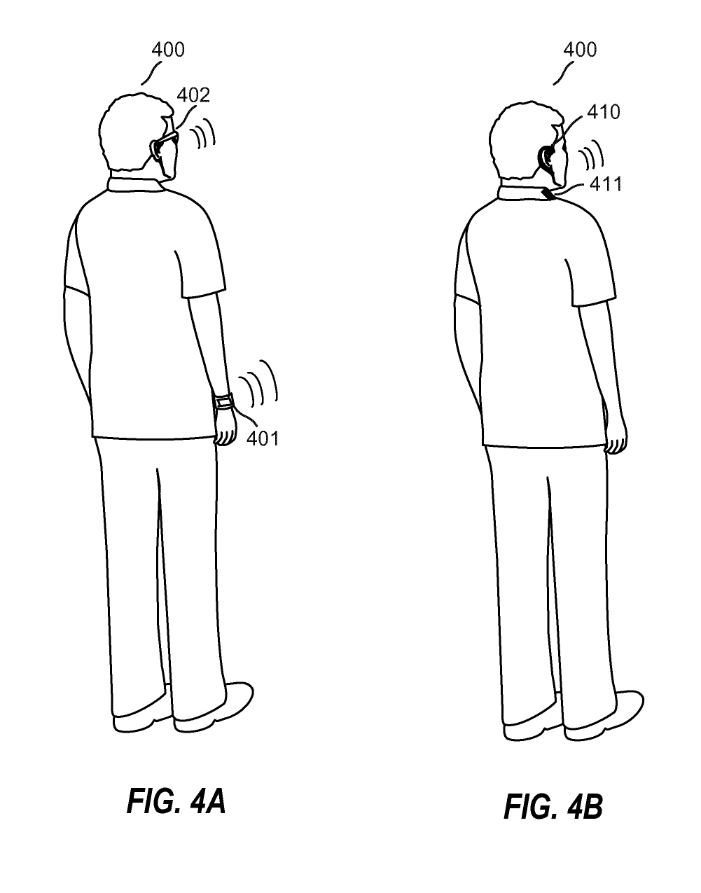

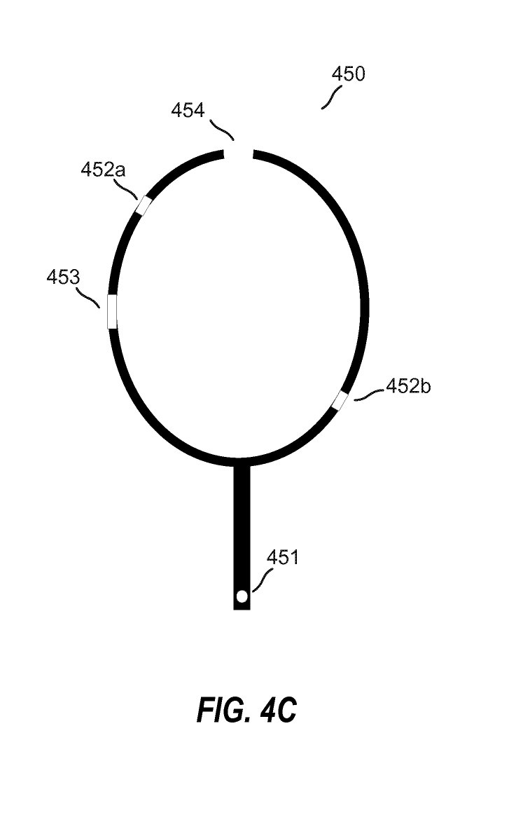

FIGS. 4A-C illustrate exemplary types of sensors in various embodiments for obtaining biometric information from a user. In embodiments, sensors shown in FIGS. 4A-C are wearable by a user 400 and may correspond to sensor 105 shown in FIG. 1. In embodiments, sensors are included in wearable computing devices that communicate with other computing devices by wired or wireless connections. Alternatively, sensors are not included with computing devices and may communicate with computing devices by a wired or wireless connection. Sensors may be included and packaged with other devices, such as a camera, processor, memory, antenna and/or display. In embodiments, multiple sensors may be included in a wearable computing device or worn by a user.

FIG. 4A illustrates a sensor in glasses 401 and watch 402. In an embodiment, glasses 401 and watch 402, each have one or more sensors to obtain biometric information. Glasses 401 may have a surface of a sensor that contacts a temple or ear of user 400 to obtain biometric information. In an embodiment, glasses 401 includes a camera, such as image capture device 104 shown in FIG. 1. Also, glasses 401 may include a display on a lens of glasses 401, where the display provides information to user 400.

Similarly, watch 402 may have a surface of a sensor that contacts a wrist of user 400 to obtain biometric information.

FIG. 4B illustrates an earpiece 410 and clip 411 worn by a user 400 that each may include one or more sensors to obtain biometric information. In an embodiment earpiece 410 is worn on an ear of user 400, while clip 411 is worn on an article of clothing (such as a collar of a shirt) or worn as a pendant. In an embodiment, earpiece 410 and clip 411 have surfaces of sensors that contact user 400 to obtain biometric information. In an embodiment, earpiece 410 also includes an image capture device and microphone. In an embodiment, clip 411 also includes an image capture device.

FIG. 4C illustrates a necklace 450 having one or more biometric sensors. Necklace 450 may be made of an elastic or bendable material that allows user 400 to bend opening 454 wider to position necklace 450 on a neck of user 400. Necklace 450 includes sensors 452a-b that may include light emitting diodes (LEDs) to determine heart rate, electrodes for skin conductance, accelerometer (for chewing patterns in an embodiment) and/or temperature sensor. A camera 451 may be hung from necklace 450. In an embodiment camera 451 is a fish eye lens camera. Antenna 453 is included in necklace 450 and used to communicate or output the biometric information from sensors 452a-b. A similar antenna may be included with the other sensors illustrated in FIG. 4A-C.

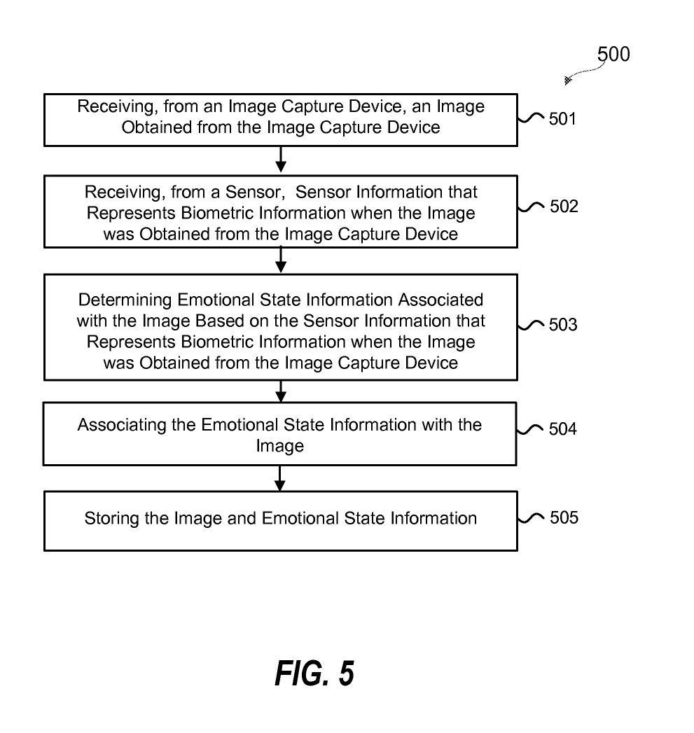

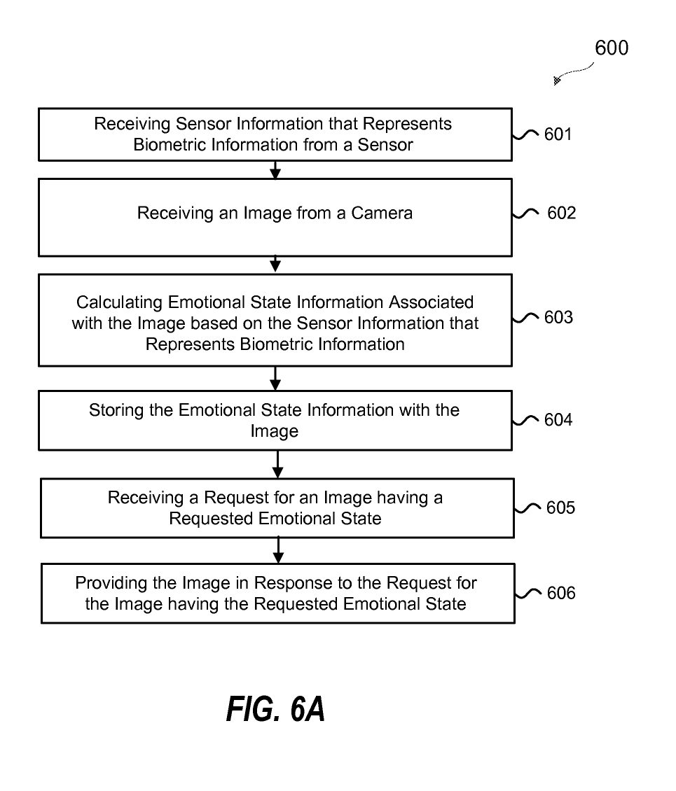

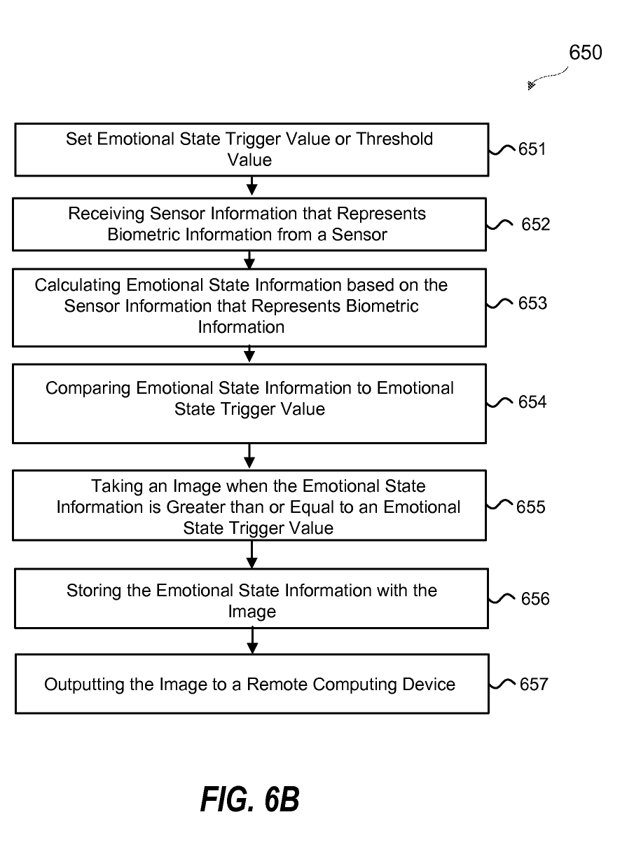

FIGS. 5 and 6A-B are flow charts illustrating exemplary methods of processing images tagged with biometric and/or emotional state information. In embodiments, blocks illustrated in FIGS. 5 and 6A-B represent the operation of hardware (e.g., processor, memory, circuits), software (e.g., operating system, applications, drivers, machine/processor readable instructions), or a user, singly or in combination. As one of ordinary skill in the art would understand, embodiments may include less or more blocks shown.

FIG. 5 is a flow chart illustrating method 500 for processing and storing an image with emotional state information. In an embodiment method 500 is performed by computing device 101 and at least some of the software components shown in FIG. 1.

Block 501 represents receiving, from an image capture device, an image obtained from the image capture device. In an embodiment, a user 111 uses image capture device 104 to obtain an image 106 as illustrated in FIG. 1.

Block 502 illustrates receiving, from a sensor, sensor information that represents biometric information when the image 106 was obtained from the image capture device. In an embodiment, sensor 105 as illustrated in FIG. 1 obtains biometric information 108 from user 111. In an embodiment, sensor 105 corresponds to one or more wearable sensors illustrated in FIGS. 4A-C.

Block 503 illustrates determining emotional state information associated with the image 106 based on the sensor information that represents biometric information 108 when the image was obtained from the image capture device 104. In an embodiment, image tagger 102b, and in particular calculate emotional state 202 calculates and assigns an emotional state value or number to the image 106.

Block 504 illustrates associating the emotional state information with the image. In an embodiment, image tagger 102b, and in particular store emotional state value with image 203 associates the assigned emotional state value with the image 106. In an embodiment, store emotional state value with image 203 writes an assigned emotional state value into the metadata of the image 106.

Block 505 illustrates storing the image and emotional state information. In an embodiment, store emotional state value with image 203 stores the image with an emotional state value in metadata in tagged images 102c such that image search engine 102d may retrieve, sort and/o organize the image (along with other images) based on the image's tagged emotional state value (or emotional state value stored in metadata).

FIG. 6A is a flow chart illustrating a method 600 for processing, storing and retrieving an image having emotional state information. In an embodiment, method 600 is performed by computing device 101 and at least some of the software components shown in FIG. 1.

Block 601 represents receiving sensor information that represents biometric information from a sensor. In an embodiment, sensor 105 as illustrated in FIG. 1 obtains biometric information 108 from user 111. In an embodiment, sensor 105 corresponds to one or more wearable sensors illustrated in FIGS. 4A-C.

Block 602 illustrates receiving an image from a camera. In an embodiment, a user 111 uses image capture device 104 to obtain an image 106 as illustrated in FIG. 1. In an alternate embodiment, a user 111 views an image that was not taken by user 111 on a display.

Block 603 illustrates calculating emotional state information associated with the image based on the sensor information that represents biometric information. In an embodiment, image tagger 102b, and in particular calculate emotional state 202 calculates and assigns an emotional state value or number to the image 106. In an embodiment, a user 111 may be viewing a plurality of images of merchandise or vacation destinations and the biometric information may indicate an emotional state of the user associated with the merchandise or vacation destination.

Block 604 illustrates storing the image and emotional state information. In an embodiment, store emotional state value with image 203 stores the image 106 with an emotional state value in metadata in tagged images 102c.

Block 605 illustrates receiving a request for an image (or images) having a requested emotional state. For example, user 111 may request an image that has the highest happiness value or all images with a happiness emotional state value (or all images having an emotional state value in happy range 353 shown in FIG. 3B). In an embodiment, computing device 101 receives a request for an image having a requested emotional state from a user 111 at a user interface of computing device 101 and directs the request to image search engine 102d shown in FIG. 1. In an alternate embodiment, a user may request an image having a particular biometric value or information, such as any image with a heart rate exceeding 100 beats per second.

Block 606 illustrates providing the image (or images) in response to the request for the image having the requested emotional state or value. In an embodiment, image search engine 102d may retrieve, sort and/or organize images based on an image's tagged emotional state (or emotional state value stored in metadata). In an embodiment, image search engine 102d searches for images in tagged images 102c having the requested emotional state value; in particular image search engine 102d searches the metadata of images stored in tagged images 102c. Image search engine 102d may then provide the results to a user interface, such as a user interface of computing device 101.

Image search engine 102d may retrieve specific images having specific emotional state values as well as sort retrieved images based on requested emotional state values. For example, image search engine 102 may provide all the images with a particular emotional state, such as a happy emotional state, in a numeric descending or ascending order. Accordingly, the images may be viewed from happiest to least happy in the happiness emotional state range or vice versa.

Also, image search engine 102d may search tagged images 102c and organize images into files based on emotional state values. For example, all the images with an assigned happiness emotional state value may be stored in a happiness image file while all the images with an assigned angry emotional state value may be organized and stored in another file, labeled as such.

FIG. 6B is a flow chart illustrating a method 650 for processing, storing and outputting an image having emotional state information. In an embodiment, method 650 is performed by computing device 101 and at least some of the software components shown in FIG. 1.

Block 651 represents setting an emotional state trigger value or threshold value. In an embodiment, a user inputs an emotional state trigger value using a user interface, on for example computing device 101. A user may input an emotional state trigger value of 80, for example, that corresponds to a beginning of a happy range 352 as shown in FIG. 3B. This indicates that a user wants to have an image taken when the user's emotional state is greater than or equal to 80 in an embodiment, or when the user is in a happy range 352. In an embodiment, a menu may be provided to a user to select particular emotional states that are intended to be captured by way of an image.

Block 652 represents receiving sensor information that represents biometric information from a sensor. In an embodiment, sensor 105 as illustrated in FIG. 1 obtains biometric information 108 from user 111. In an embodiment, sensor 105 corresponds to one or more wearable sensors illustrated in FIGS. 4A-C.

Block 653 represents calculating emotional state information based on the sensor information that represents biometric information. In embodiments, an emotional state or emotional state information is calculated based on the sensor information as described herein.

Block 654 represents comparing emotional state information to an emotional state trigger value. In an embodiment, one or more emotional state trigger values that may be input by users are stored in control 102a as illustrated in FIG. 1. In an embodiment, an emotional state trigger value is compared with a calculated emotional state value by control 102a that outputs control signal 107a to trigger or take an image by image capture device 104 in response to the comparison.

Block 655 represents taking an image when the calculated emotional state information is greater than or equal to an emotional state trigger value. In an embodiment, image capture device 104 captures or takes an image in response to control signals output from control 102a.

Block 656 represents storing the emotional state information with the image. In an embodiment, block 656 also represents receiving the image. In embodiments, the emotional state information is stored with the image as described herein.

Block 657 represents outputting the tagged image to a remote computing device, such as a computing device that provides social media to others. Tagged images or images stored with emotional state information may be used in social media, such as social media connections or social media broadcasting. Tagged images may be created and selectively provided to others by way of social media based on a specific user provided value that represents an emotional state intended to be captured in an image. This would enable a user to blog or broadcast (a.k.a. “lifecasting”) specific emotional images to others by way of social media.

In embodiments, a user may select to not blog or broadcast particular tagged images or a computing device may request permission before providing the tagged images to a particular social media.

In an embodiment, computing device 101, image capture device 104 and sensor 105 (shown in FIG. 1), singly or in combination, may be included in a gaming and media system. FIG. 7 illustrates an exemplary video game and media console, or more generally, will be used to describe an exemplary gaming and media system 1000 that includes a game and media console. For example, console 1002 (as described in detail herein) may correspond to computing device 101, camera 1090 may correspond to image capture device 104, and sensors 1099₁₋₂ on a controller 1004₂ may correspond to one or more sensors 105. In an alternate embodiment, a natural language interface (NUI) that interprets facial expressions included in gaming and media system 1000 corresponds to sensor 105.

The following discussion of FIG. 7 is intended to provide a brief, general description of a suitable computing device with which concepts presented herein may be implemented. It is understood that the system illustrated in FIG. 7 is exemplary. In further examples, embodiments describe herein may be implemented using a variety of client computing devices, either via a browser application or a software application resident on and executed by the client computing device. As shown in FIG. 7, a gaming and media system 1000 includes a game and media console (hereinafter “console”) 1002. In general, the console 1002 is one type of client computing device. The console 1002 is configured to accommodate one or more wireless controllers, as represented by controllers 1004₁ and 1004₂. The console 1002 is equipped with an internal hard disk drive and a portable media drive 1006 that support various forms of portable storage media, as represented by an optical storage disc 1008. Examples of suitable portable storage media include DVD, CD-ROM, game discs, and so forth. The console 1002 also includes two memory unit card receptacles 1025₁ and 1025₂, for receiving removable flash-type memory units 1040. A command button 1035 on the console 1002 enables and disables wireless peripheral support.

As depicted in FIG. 7, the console 1002 also includes an optical port 1030 for communicating wirelessly with one or more devices and two USB ports 1010₁ and 1010₂ to support a wired connection for additional controllers, or other peripherals, such as a camera 1090. In some implementations, the number and arrangement of additional ports may be modified. A power button 1012 and an eject button 1014 are also positioned on the front face of the console 1002. The power button 1012 is selected to apply power to the game console, and can also provide access to other features and controls, and the eject button 1014 alternately opens and closes the tray of a portable media drive 1006 to enable insertion and extraction of an optical storage disc 1008.

The console 1002 connects to a television or other display (such as display 1050) via A/V interfacing cables 1020. In one implementation, the console 1002 is equipped with a dedicated A/V port configured for content-secured digital communication using A/V cables 1020 (e.g., A/V cables suitable for coupling to a High Definition Multimedia Interface “HDMI” port on a high definition display 1050 or other display device). A power cable 1022 provides power to the game console. The console 1002 may be further configured with broadband capabilities, as represented by a cable or modem connector 1024 to facilitate access to a network, such as the Internet. The broadband capabilities can also be provided wirelessly, through a broadband network such as a wireless fidelity (Wi-Fi) network.

Each controller 1004 is coupled to the console 1002 via a wired or wireless interface. In the illustrated implementation, the controllers 1004 are USB-compatible and are coupled to the console 1002 via a wireless or USB port 1010. The console 1002 may be equipped with any of a wide variety of user interaction mechanisms. In an example illustrated in FIG. 7, each controller 1004 is equipped with two thumb sticks 1032₁ and 1032₂, a D-pad 1034, buttons 1036, and two triggers 1038. These controllers are merely representative, and other known gaming controllers may be substituted for, or added to, those shown in FIG. 7. In an embodiment, controller 1032₁ includes one or more sensors 1099₁₋₂ to obtain biometric information from a user holding controller 1032₁. In an embodiment, biometric information is transferred to console 1002 with other control information from the controllers.

In an embodiment, camera 1090 is USB-compatible and is coupled to the console 1002 via a wireless or USB port 1010.

In an embodiment, a user may enter input to console 1002 by way of gesture, touch or voice. In an embodiment, optical I/O interface 1135 receives and translates gestures of a user, including facial expressions. In another embodiment, console 1002 includes a NUI to receive and translate voice and gesture (including facial expressions) inputs from a user. In an alternate embodiment, front panel subassembly 1142 includes a touch surface and a microphone for receiving and translating a touch or voice, such as a voice command, of a user.

In one implementation, a memory unit (MU) 1040 may also be inserted into the controller 1004 to provide additional and portable storage. Portable MUs enable users to store game parameters for use when playing on other consoles. In this implementation, each controller is configured to accommodate two MUs 1040, although more or less than two MUs may also be employed.

The gaming and media system 1000 is generally configured for playing games stored on a memory medium, as well as for downloading and playing games, and reproducing pre-recorded music and videos, from both electronic and hard media sources. With the different storage offerings, titles can be played from the hard disk drive, from an optical storage disc media (e.g., 1008), from an online source, or from MU 1040. Samples of the types of media that gaming and media system 1000 is capable of playing include:

Game titles or applications played from CD, DVD or higher capacity discs, from the hard disk drive, or from an online source.

Digital music played from a CD in portable media drive 1006, from a file on the hard disk drive or solid state disk, (e.g., music in a media format), or from online streaming sources.

Digital audio/video played from a DVD disc in portable media drive 1006, from a file on the hard disk drive (e.g., Active Streaming Format), or from online streaming sources.

During operation, the console 1002 is configured to receive input from controllers 1004₁₋₂ and display information on the display 1050. For example, the console 1002 can display a user interface on the display 1050 to allow a user to select an electronic interactive game using the controller 1004 and display state solvability information as discussed below.

FIG. 8 is a functional block diagram of the gaming and media system 1000 and shows functional components of the gaming and media system 1000 in more detail. The console 1002 has a central processing unit (CPU) 1100, and a memory controller 1102 that facilitates processor access to various types of memory, including a flash ROM 1104, a RAM 1106, a hard disk drive or solid state drive 1108, and the portable media drive 1006. In alternate embodiments, CPU 1100 is replaced with a plurality of processors. In alternate embodiments, other types of volatile and non-volatile memory technologies may be used. In one implementation, the CPU 1100 includes a level 1 cache 1110 and a level 2 cache 1112, to temporarily store data and hence reduce the number of memory access cycles made to the hard drive 1108, thereby improving processing speed and throughput.

The CPU 1100, the memory controller 1102, and various memories are interconnected via one or more buses. The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures.

In embodiments, CPU 1100 includes processor cores that executes (or reads) processor (or machine) readable instructions stored in processor readable memory. An example of processor readable instructions may include control 102a, image tagger 102b, tagged images 102c and image search engine 102d shown in FIG. 1. In an embodiment, processor cores may include a processor and memory controller or alternatively a processor that also performs memory management functions similarly performed by a memory controller. Processor cores may also include a controller, graphics-processing unit (GPU), digital signal processor (DSP) and/or a field programmable gate array (FPGA). In an embodiment, high performance memory is positioned on top of a processor cores.

Types of volatile memory include, but are not limited to, dynamic random access memory (DRAM), molecular charge-based (ZettaCore) DRAM, floating-body DRAM and static random access memory (“SRAM”). Particular types of DRAM include double data rate SDRAM (“DDR”), or later generation SDRAM (e.g., “DDRn”).

Types of non-volatile memory include, but are not limited to, types of electrically erasable program read-only memory (“EEPROM”), FLASH (including NAND and NOR FLASH), ONO FLASH, magneto resistive or magnetic RAM (“MRAM”), ferroelectric RAM (“FRAM”), holographic media, Ovonic/phase change, Nano crystals, Nanotube RAM (NRAM-Nantero), MEMS scanning probe systems, MEMS cantilever switch, polymer, molecular, nano-floating gate and single electron.

A three-dimensional graphics processing unit 1120 and a video encoder 1122 form a video processing pipeline for high speed and high resolution (e.g., High Definition) graphics processing. Data are carried from the graphics processing unit 1120 to the video encoder 1122 via a digital video bus. An audio processing unit 1124 and an audio codec (coder/decoder) 1126 form a corresponding audio processing pipeline for multi-channel audio processing of various digital audio formats. Audio data are carried between the audio processing unit 1124 and the audio codec 1126 via a communication link. The video and audio processing pipelines output data to an A/V (audio/video) port 1128 for transmission to a television or other display.

FIG. 8 shows the module 1114 including a USB host controller 1130 and a network interface 1132. The USB host controller 1130 is shown in communication with the CPU 1100 and the memory controller 1102 via a bus (e.g., PCI bus) and serves as host for the peripheral controllers 1004₁-1004₄. The network interface 1132 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 8, the console 1002 includes a controller support subassembly 1140 for supporting the four controllers 1004₁-1004₄. The controller support subassembly 1140 includes any hardware and software components to support wired and wireless operation with an external control device, such as for example, a media and game controller. A front panel I/O subassembly 1142 supports the multiple functionalities of power button 1012, the eject button 1014, as well as any LEDs (light emitting diodes) or other indicators exposed on the outer surface of console 1002. Subassemblies 1140 and 1142 are in communication with the module 1114 via one or more cable assemblies 1144. In other implementations, the console 1002 can include additional controller subassemblies. The illustrated implementation also shows an optical I/O interface 1135 that is configured to send and receive signals that can be communicated to the module 1114.

The MUs 1040₁ and 1040₂ are illustrated as being connectable to MU ports “A” 1030₁ and “B” 1030₂ respectively. Additional MUs (e.g., MUs 1040₃-1040₆) are illustrated as being connectable to the controllers 1004₁ and 1004₃, i.e., two MUs for each controller. The controllers 1004₂ and 1004₄ can also be configured to receive MUs. Each MU 1040 offers additional storage on which electronic interactive games, game parameters, and other data may be stored. In some implementations, the other data can include any of a digital game component, an executable gaming application, an instruction set for expanding a gaming application, and a media file. When inserted into the console 1002 or a controller, the MU 1040 can be accessed by the memory controller 1102.

A system power supply module 1150 provides power to the components of the gaming system 1000. A fan 1152 cools the circuitry within the console 1002.

At least portions of control 102a, image tagger 102b, tagged images 102c and image search engine 102d are stored on the hard disk drive 1108. When the console 1002 is powered on, various portions of control 102a, image tagger 102b, tagged images 102c and image search engine 102d are loaded into RAM 1106, and/or caches 1110 and 1112, for execution on the CPU 1100. In embodiments other applications, such as application 1160, can be stored on the hard disk drive 1108 for execution on CPU 1100.

The console 1002 is also shown as including a communication subsystem 1170 configured to communicatively couple the console 1002 with one or more other computing devices (e.g., other consoles). The communication subsystem 1170 may include wired and/or wireless communication devices compatible with one or more different communication protocols. As non-limiting examples, the communication subsystem 1170 may be configured for communication via a wireless telephone network, or a wired or wireless local- or wide-area network. In some embodiments, the communication subsystem 1170 may allow the console 1002 to send and/or receive messages to and/or from other devices via a network such as the Internet. In specific embodiments, the communication subsystem 1170 can be used to communicate with a coordinator and/or other computing devices, for sending download requests, and for effecting downloading and uploading of digital content. More generally, the communication subsystem 1170 can enable the console 1002 to participate on peer-to-peer communications.

The gaming and media system 1000 may be operated as a standalone system by simply connecting the system to display 1050 (FIG. 7), a television, a video projector, or other display device. In this standalone mode, the gaming and media system 1000 enables one or more players to play electronic interactive games, or enjoy digital media, e.g., by watching movies, or listening to music. However, with the integration of broadband connectivity made available through network interface 1132, or more generally the communication subsystem 1170, the gaming and media system 1000 may further be operated as a participant in a larger network gaming community, such as a peer-to-peer network.

The above described gaming and media system 1000 is just one example of a computing device 101, image capture device 104 and sensor 105 discussed above with reference to FIG. 1 and various other Figures. As was explained above, there are various other types of computing devices with which embodiments described herein can be used.

FIG. 9 is a block diagram of one embodiment of a computing device 1800 which may host at least some of the software components illustrated in FIGS. 1 and 2 (and corresponds to computing device 101 in an embodiment). In embodiments, image capture device 104 and/or sensor 105 are included or external to computing device 1800. In an embodiment, computing device 1800 is a mobile device such as a cellular telephone, or tablet, having a camera. Sensor 105 may be included with computing device 1800 or may be external to computing device 1800, such as wearable sensors as described herein.

In its most basic configuration, computing device 1800 typically includes one or more processor(s) 1802 including one or more CPUs and one or more GPUs. Computing device 1800 also includes system memory 1804. Depending on the exact configuration and type of computing device, system memory 1804 may include volatile memory 1805 (such as RAM), non-volatile memory 1807 (such as ROM, flash memory, etc.) or some combination of the two. This most basic configuration is illustrated in FIG. 9 by dashed line 1806. Additionally, device 1800 may also have additional features/functionality. For example, device 1800 may also include additional storage (removable and/or non-removable) including, but not limited to, magnetic or optical discs or tape. Such additional storage is illustrated in FIG. 9 by removable storage 1808 and non-removable storage 1810.

Device 1800 may also contain communications connection(s) 1812 such as one or more network interfaces and transceivers that allow the device to communicate with other devices. Device 1800 may also have input device(s) 1814 such as keyboard, mouse, pen, voice input device, touch input device, gesture input device, etc. Output device(s) 1816 such as a display, speakers, printer, etc. may also be included. These devices are well known in the art so they are not discussed at length here.

In embodiments, a user will be notified that biometric information will be recorded and emotional state information may be calculated before any such action occurs. In embodiments, a user may opt in or opt out of having emotional state/biometric information received and/or stored in a computing device and/or in images after notification. Further, a user may be able to adjust or erase emotional state/biometric information assigned to a particular image or stored in a computing device.

The flowcharts and block diagrams in the Figures illustrate the architecture, functionality, and operation of possible implementations of systems (apparatus), methods and a computer (software) programs, according to embodiments. In this regard, each block in the flowchart or block diagram may represent a software component. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and software components.

In embodiments, illustrated and/or described signal paths are media that transfers a signal, such as an interconnect, conducting element, contact, pin, region in a semiconductor substrate, wire, metal trace/signal line, or photoelectric conductor, singly or in combination. In an embodiment, multiple signal paths may replace a single signal path illustrated in the figures and a single signal path may replace multiple signal paths illustrated in the figures. In embodiments, a signal path may include a bus and/or point-to-point connection. In an embodiment, a signal path includes control and data signal lines. In still other embodiments, signal paths are unidirectional (signals that travel in one direction) or bidirectional (signals that travel in two directions) or combinations of both unidirectional signal lines and bidirectional signal lines.

The foregoing detailed description of the inventive system has been presented for purposes of illustration and description. It is not intended to be exhaustive or to limit the inventive system to the precise form disclosed. Many modifications and variations are possible in light of the above teaching. As used herein, the singular forms “a”, “an” and “the” are intended to include the plural forms as well, unless the context clearly indicates otherwise. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed is:

1. A method to operate a computing device, the method comprising:
receiving, from an image capture device, an image obtained from the image capture device;
receiving, from a sensor, sensor information that represents biometric information when the image was obtained from the image capture device;
determining emotional state information associated with the image based on the sensor information that represents biometric information when the image was obtained from the image capture device;
associating the emotional state information with the image; and
storing the image and emotional state information.

2. The method of claim 1, wherein the sensor and image capture device is included in a single computing device.

3. The method of claim 1, wherein the sensor is a wearable sensor and the image capture device is a camera, wherein the wearable sensor is included in a first computing device and the camera is included in a second separate computing device.

4. The method of claim 1, wherein the determining the emotional state is performed, at least in part, by a processor in the computing device executing processor readable instructions, stored in a processor readable memory, in response to the sensor information.

5. The method of claim 4, wherein storing the image and emotional state information includes storing emotional state information as a number in metadata of the image, wherein the image and emotional state information is stored in processor readable memory.

6. The method of claim 1, wherein the sensor is configured so as to obtain sensor information that includes at least one of include heart rate, galvanic skin response (GSR), facial expression, temperature, glucose level or hydration.

7. The method of claim 6, wherein the sensor information is obtained from a user that causes the image to be obtained from the image capture device.

8. The method of claim 7, wherein the associating includes storing the emotional state information in metadata of the image.

9. The method of claim 8, wherein the determining the emotional state information includes assigning a number in a range of numbers associated with a range of emotions of the user, wherein the assigning the number in the range of numbers is based on the sensor information.

10. The method of claim 9, wherein the range of emotions of the user includes at least happiness, sadness and anger, wherein a first set of numbers in the range of numbers is associated with happiness, a second set of numbers in the range of numbers is associated with sadness and a third set of numbers in the range of numbers is associated with anger.

11. An apparatus comprising;
at least one sensor to obtain biometric data;
at least one camera to obtain an image;
at least one processor; and
at least one processor readable memory to store processor readable instructions,
wherein the at least one processor executes the processor readable instructions to:
receive sensor information that represents biometric information from the sensor,
receive the image from the camera,
calculate emotional state information associated with the image based on the sensor information that represents biometric information, and
store the emotional state information with the image.

12. The apparatus of claim 11, wherein at least one sensor to obtain biometric information, at least one camera to obtain the image, at least one processor and at least one processor readable memory to store processor readable instructions are stored in a single computing device.

13. The apparatus of claim 11, wherein the at least one sensor to obtain biometric information is included in a wearable device and the at least one camera to obtain the image, at least one processor and at least one processor readable memory to store processor readable instructions are included in a separate computing device.

14. The apparatus of claim 11, wherein the at least one sensor is configured so as to obtain sensor information that includes at least one of heart rate, galvanic skin response (GSR), facial expression, temperature, glucose level or hydration, wherein the sensor information is obtained from a user that causes the image to be obtained from the camera, and wherein calculate the emotional state information includes assign a number in a range of numbers associated with a range of emotions of the user, wherein the assign the number in the range of numbers is based on the sensor information.

15. The apparatus of claim 11, wherein the apparatus is included in a game and media console.

16. One or more processor readable memories having instructions encoded thereon which when executed cause one or more processors to perform a method for processing an image, the method comprising:
receiving sensor information that represents biometric information from a sensor;
receiving an image from a camera;
calculating emotional state information associated with the image based on the sensor information that represents biometric information;
storing the emotional state information with the image;
receiving a request for the image having a requested emotional state; and
providing the image in response to the request for the image having the requested emotional state.

17. The one or more processor readable memories of claim 16, wherein sensor information includes at least one of heart rate, galvanic skin response (GSR), facial expression, temperature, glucose level or hydration.

18. The one or more processor readable memories of claim 17, wherein the sensor information represent biometric information of a user and the user causes the camera to obtain the image, wherein the calculating the emotional state information includes assigning a number in a range of numbers associated with a range of emotions of the user, wherein the assigning the number in the range of numbers is based on the sensor information.

19. The one or more processor readable memories of claim 18, wherein the range of emotions of the user includes at least happiness, sadness and anger, wherein a first set of numbers in the range of numbers is associated with happiness, a second set of numbers in the range of numbers is associated with sadness and a third set of numbers in the range of numbers is associated with anger.

20. The one or more processor readable memories of claim 16, wherein the storing the emotional state information with the image includes storing the emotional state information in metadata of the image that is retrievable during providing the image in response for the request for the image having the requested emotional state.
